(19) United States
(12) Patent Application Publication
(10) Pub. No.: US 2014/0363002 A1
(43) Pub. Date: Dec. 11, 2014

(54) INDICATION OF QUALITY FOR PLACEMENT OF BONE CONDUCTION TRANSDUCERS

(71) Applicant: DSP Group, San Jose, CA (US)

(72) Inventors: Haim Kupershmidt, Herzelia (IL); Lior Blanka, Herzelia (IL)

(21) Appl. No.: 14/299,809

(22) Filed: Jun. 9, 2014

Related U.S. Application Data
(60) Provisional application No. 61/832,868, filed on Jun. 9, 2013.

(51) Int. Cl. H04R 29/00

(52) U.S. Cl. CPC H04R 29/00
USPC 381/58

(57) ABSTRACT

Methods and systems are provided for generating quality indications of bone conduction, in which bone conduction element(s) may be used to input and/or output signals when in contact with a user. A bone conduction sensor may be used to obtain bone conduction related measurement(s), relating to the bone conduction element(s) and/or operations thereof. The bone conduction measurement(s) may be processed, such as to determine or estimate quality of attachment and/or performance of the bone conduction elements. Quality indication(s) may then be generated based on the assessed quality of bone conduction, and may be configured for presentation to a user.

### CLAIM OF PRIORITY

This patent application makes reference to, claims priority to and claims benefit from the U.S. Provisional Patent Application No. 61/832,868, filed on Jun. 9, 2013, which is hereby incorporated herein by reference in its entirety.

### TECHNICAL FIELD

Aspects of the present application relate to audio processing. More specifically, certain implementations of the present disclosure relate to methods and systems for providing indications of quality for placement of bone conduction transducers.

### BACKGROUND

Existing methods for ensuring quality of placement of bone conduction transducers may be inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for indication of quality for placement of bone conduction transducers, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates examples of arrangements that incorporate bone conduction elements.

FIG. 2A illustrates charts of example magnitude and phase characteristics associated with bone conduction, based on type of contact.

FIG. 2B illustrates charts of example transmission gain profiles based on applied force and different frequencies of the signal.

FIG. 3 illustrates an example electronic device that may support managing quality of bone conduction operations.

FIG. 4 illustrates an example system that may support assessing quality of bone conduction, and providing quality based indications to users.

FIG. 5 illustrates an example system that may support assessing quality of bone conduction done using a single bone conduction transducer, and providing quality based indications to users.

FIG. 6 is a flowchart illustrating an example process for generating quality indications for bone conduction based on measurement.

### DETAILED DESCRIPTION

Certain example implementations may be found in method and system for non-intrusive noise cancellation in electronic devices, particularly in user-supported devices. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

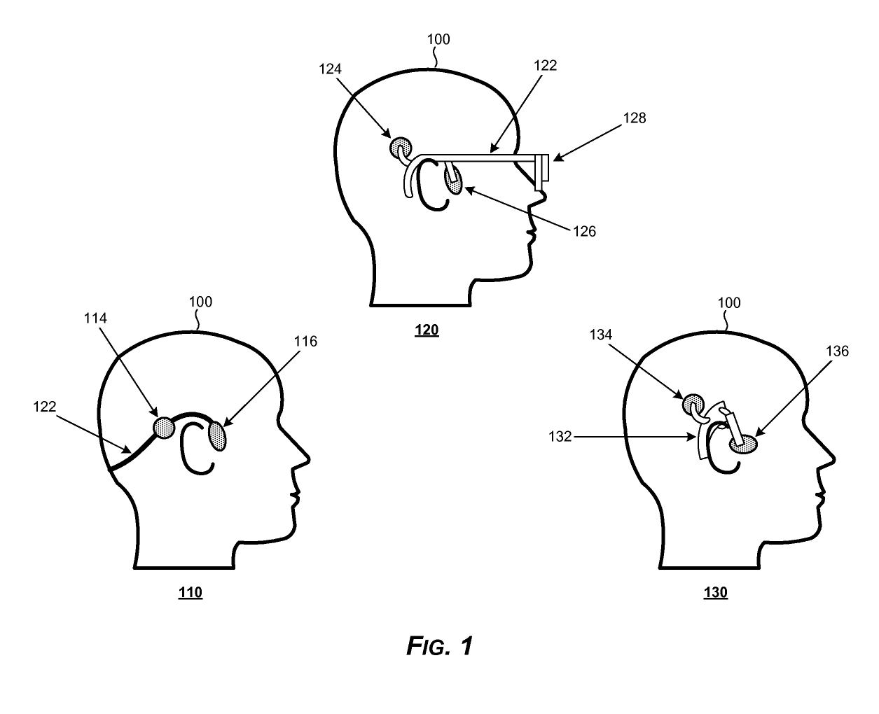

FIG. 1 illustrates examples of arrangements that incorporate bone conduction elements. Shown in FIG. 1 are different bone conduction arrangements 110, 120, and 130, which may be utilized to provide bone conduction operations with respect to a user 100.

In each of the bone conduction arrangements 110, 120, and 130, one or more bone conduction elements may be placed in contact with a user 100, to enable bone conduction operations with respect to a user 100. In this regard, bone conduction may be used in injecting acoustic signals directly through skull bones, to be captured by internal parts of a user's ears (thus bypassing the eardrums). For example, a bone conduction device may be a special earphone or headphone containing a bone conduction element (e.g., transducer), which may be configured to be in contact with the user's bones (e.g., skull bones). The contact may be made in particular location, which may provide optimal performance. For example, contact may usually be made behind the ear or in front of the ear, touching the skull. Bone conduction transducers may be driven by relatively high power audio amplifiers, in order to set up sufficient bone vibrations. While bone conduction devices are often provided to people with special needs (e.g., hearing disabilities), these devices may also be used in lieu of (or in addition to) typical speakers—e.g., a replacement for regular earphones where it is important not to block a user's hearing with respect to the surrounding sounds, such as when a user may need to be aware of his/her surroundings. For example, if a user is walking or running on or adjacent to a street, the user may need to be aware of surrounding sounds, such as traffic. Accordingly, blocking of environmental sounds may be dangerous, as it may make the user less aware of possible safety risks. Using bone conduction devices, however, may ensure that the eardrums remain open, thus allowing users to remain aware of their surroundings.

Bone conduction devices (and/or elements) may be used as, for example, stand-alone devices, for example as earpieces coupled with communication devices (e.g., a Bluetooth earpiece for use with mobile devices), and/or as components in wearable devices (e.g., Google Glass). For example, the bone conduction arrangement 110 may comprise a bone conduction headset 112 which the user 110 may wear, comprising bone conduction elements 114 and 116. In this regard, the bone conduction element 116 may be situated just in front of the user's ear, and be coupled to the skull, whereas the bone conduction element 114 may be located above and behind the ear. The bone conduction arrangement 120 may comprise a wearable computer device 122 (e.g., Google Glass or the like), with a head mounted display 128. The wearable computer device 122 may comprise two bone conduction elements 124 and 126, connected to the device part resting on a user's ear. The bone conduction element 124 may be located above and behind the ear (and making contact with the skull); whereas the bone conduction element 126 may be located in front of the ear. The bone conduction arrangement 130 may comprise a bone conduction earpiece 132 (e.g., Bluetooth earpiece or the like), which the user 110 may wear over his/her ear. The bone conduction earpiece 132 may comprise two bone conduction elements 134 and 136, connected to the earpiece 132. The bone conduction element 134 may be integrated into main body of the earpiece 132, behind and above the ear, whereas the bone conduction element 136 may be connected to the earpiece 132 such that it may be placed in front of the ear. Nonetheless, it should be understood that the bone conduction arrangements 110, 120, and 130 are only provided as examples, and the disclosure is not limited to these arrangements.

Bone conduction elements may communicate audio signals in various ways. For example, bone conduction transducers may be configured to function as microphones and/or earpieces. In this regard, with audio bone conduction transducers, audio energy may be transferred from the bones to the transducer (when used as input device) and from the transducer to the bones (when use as output device). During input operations, when the user talks, for example, the sound generated by the user may vibrate the bones, and these vibrations may be captured by the bone conduction transducers and transferred to the host device for processing. During output operations, audio energy (i.e., the audio signals to be outputted) may be applied to the bone conduction sensor, and as such the audio energy may cause the bones to vibrate in a manner that may ultimately result in the audio energy being transferred to the inner ear of the user. Audio signals may be applied to bone conduction elements (i.e., during output operations) in various ways. For example, audio driver amplifiers may be used to drive bone conduction elements based on the audio signals—thus the vibrations applied by the bone conduction elements onto the bones may correspond to the audio signals.

The quality of bone conduction may depend on (or vary based on) various factors. For example, quality of bone conduction may depend on, among other things, quality of attachment of the bone conduction elements (e.g., to the bones which are expected to vibrated during input or output of audio). In this regard, optimal placement and/or attachment of bone conduction may result in optimal performance thereby. For example, optimum output levels and/or frequency response of bones conductance may strongly depend on the coupling quality of the bone conductive elements to the bones. Further, it may be desirable to allow for real-time re-assessment of quality of attachment. For example, in some instances, the attachment of the bone conduction elements to the bones may change over time, and from time to time. For example, each time the device is re-attached, or while the user is jogging or running, which causes the device to move, the volume may vary as the connection varies. Accordingly, in various implementations of the present disclosure, quality of particular aspects or characteristics of bone conduction elements or operations thereof (e.g., quality of attachment of the bone conduction elements) may be determined (including dynamically). Further, in some implementations, indications of assessed quality may be provided to users of the bone conduction elements, such as to enable the user to adjust the bone conduction elements to ensure optimal performance.

In some example implementations, quality of bone conduction may be assessed based on determining or estimating acoustic characteristics associated with bone conduction elements. Further, once the acoustic characteristics are determined or estimated, operational settings for components used in inputting or outputting of signals via the bone conduction elements may be determined (e.g., needed adjustments) based on these acoustic characteristics. For example, in some instances the quality of bone conduction may be assessed based on measurements for determining or estimating energy transfer performance of the bone conduction elements. In this regard, effective transfer of the energy between bone conduction transducers and the bones may be dependent upon acoustic impedances and the matching between them. Thus, the bone conduction quality related measurements may be directed to or be based on acoustic impedance. In this regard, impedance based measurements (and processing based thereon) may be used to assess quality of acoustic transfer at particular contact points, to enable assessing quality of attachment of bone conduction elements at these points. Further, the acoustic impedance may then be used to determine necessary settings (or adjustments thereto) for components used in the bone conduction elements (e.g., drive amplifiers) to provide similar impedance.

In some instances, impedance based measurements and processing thereof may be configured based on known and/or pre-determined acoustic impedance properties. For example, characteristic acoustic impedance Zₒ of an unbound medium may be defined as the product of the density of the medium (p) and the speed of sound (c) in that medium: Zₒ=ρc×10 [Nsm⁻³], where m is in meters, and s is in seconds. Further, for a sound wave propagating through a medium, the impedance of the medium may be equal to the complex ratio of the sound pressure, p, at a point in space to the particle velocity, v, at that same point. Thus, Zₒ=v/p where p is the sound pressure at a point in space and v is the particle velocity at that same point. Further, when the sound waves traverses different mediums, proportion of incident power transmitted from one medium to another may depend on the characteristic impedances of the different mediums. For example, the proportion (T) of incident power transmitted at an interface of media with characteristic impedances Z₁ and Z₂, respectively—e.g., transmitted from a first medium having a first characteristic impedance Z₁ to a second medium having as second characteristic impedance Z₂, may be calculated using the following equation:

$$T = \frac{4 {Z}_{1} {Z}_{2}}{{( {Z}_{1} + {Z}_{2} )}^{2}} \qquad Equation 1$$

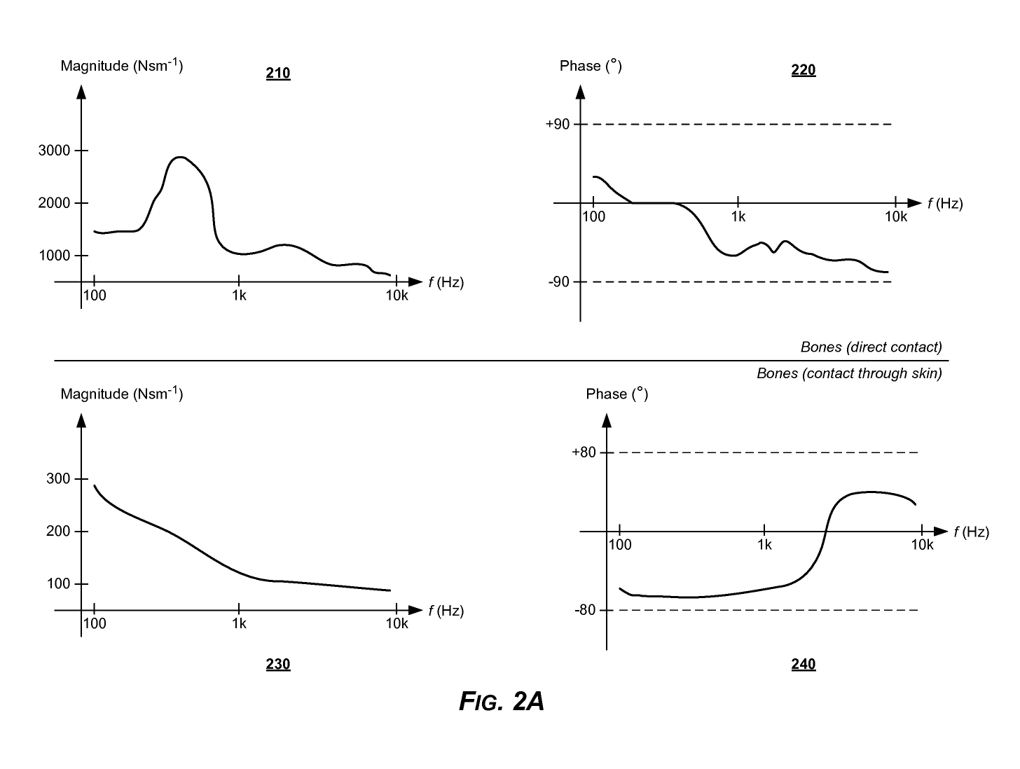

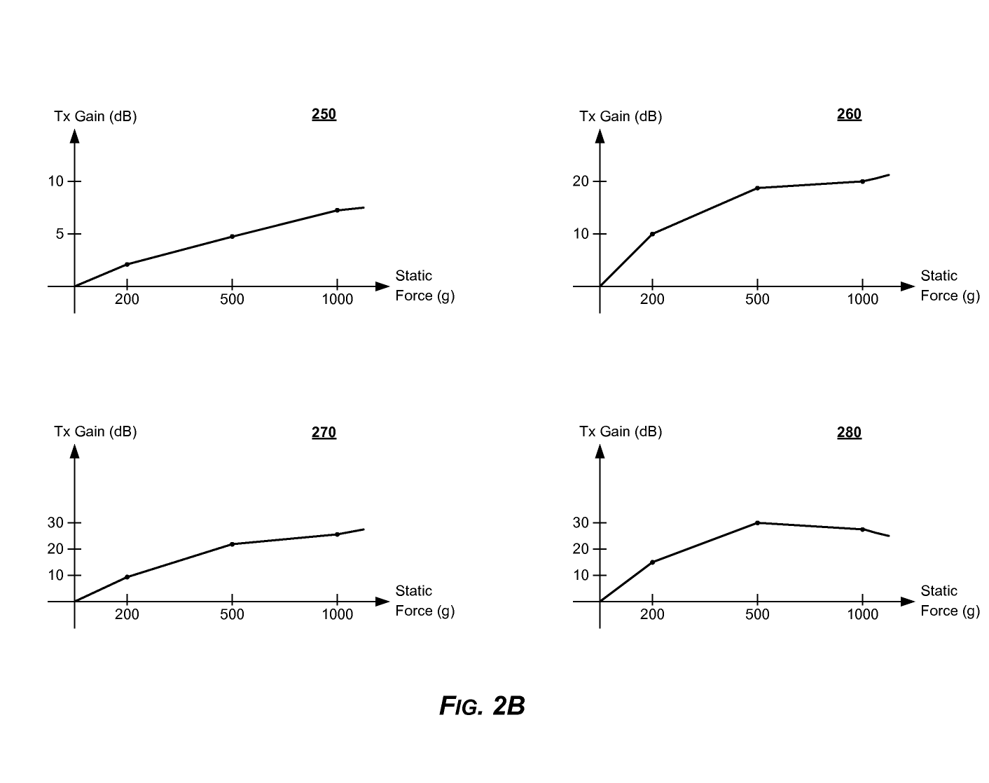

With respect to contact with skulls, particularly established impedance properties may be utilized to enable assessing optimal contact between bone conduction elements and the user's skull. For example, the mechanical (point) impedance of the human head (Z) is defined as the ratio of the magnitude of the force (F) applied to a single point on the head divided by the resulting velocity (v) of the head structure at the stimulation point, Z=F/v. The mechanical impedance of an object may represent its opposition to an external force. The higher the impedance, the more difficult it is to move or deform the medium. In order to transfer energy efficiently from one medium to another, the impedances of both mediums should be matched. When a sound wave or mechanical vibrator applies its energy on the human head, as is the case with bone conduction transducers, it may need to overcome the opposition to energy transfer by the head, caused by its impedance. Accordingly, pre-known benchmark impedance measures (e.g., as determined by experimentation and/or based on historical measured values) associated with the human skull may be used to allow for assessment of quality of contact with the skull—e.g., by comparing the dynamic measurements associated with particular contact points with pre-known benchmark impedance measures. Two impedance measures that are frequently used and/or referenced are the skin impedance (Z_{S}) and the skull impedance (Z_{T}). The skin lies fairly loosely over the bones of the skull and provides some damping of the transmission of vibration to and from the skull. FIGS. 2A and 2B provide example charts corresponding to established impedances associated with the skull.

FIG. 2A illustrates charts of example magnitude and phase characteristics associated with bone conduction, based on type of contact. Shown in FIG. 2A are charts 210, 220, 230, and 240. In this regard, charts 210 and 220 depict, respectively, example magnitude and phase characteristics (e.g., as determined by experimentation) for skull impedance (Z_{T})—i.e., when there is direct contact with the skull bones; whereas charts 230 and 240 depict, respectively, example magnitude and phase characteristics (e.g., as determined by experimentation) for skin impedance (Z_{S})—i.e., when there is contact with the skin covering the skull.

As shown in charts 210, 220, 230 and 240, bone conduction performance may vary based on frequency of signals applied thereto. Nonetheless, frequency is not the only factor. For example, experimentation has shown that better reliability of threshold data with a bone vibrator (e.g., a bone conduction transducer) that had a contact area of 1 cm² than with a comparative element that has a contact area of 3.2 cm². The effect of the contact area of the transducer may, however, vary with frequency. The characteristic impedance of boundless air, Zₒ, at normal environmental temperature (e.g., 20-22° C.), may be approximately 410 Nsm⁻³ which, for an area of 1 cm², may results in an impedance of 0.041 Nsm⁻¹. The characteristic impedance of the skull may be, however, much higher (e.g., varying between 300 and 20 Nsm⁻¹ when applying signals to skin-covered skull). Thus, according to Error! Reference source not found., described above, the fraction of energy transmitted by the bone conduction transducer may result in significant loss (e.g., in the order of −33 to −21 dB).

FIG. 2B illustrates charts of example transmission gain profiles based on applied force and characteristics of contact areas. Shown in FIG. 2B are charts 250, 260, 270, and 280. In this regard, the charts 250, 260, 270, and 280 depict transmission gain (in dB) as function of applied force (in grams, or ‘g’), such as by vibration causing elements (e.g., bone conduction transducers). In particular, the charts 250, 260, 270, and 280 may correspond to transmission gain functions associated with mediums having different dynamic viscosities—e.g., varying from 5000 cps for chart 250 to 200 cps for chart 280.

As shown in charts 250, 260, 270, and 280, application of greater levels of force may generally result in increases in transmission gain (and correspondingly decreases in the variability of sensations across individual users). For example, based on experimentations, it may be demonstrated that a force of 250-500 g may be sufficient to achieve good performance. Applying such force on a small area (e.g., ˜1 cm²) may, however, cause discomfort to the user. Further, such discomfort may grow with the force and with decreasing of the contact area. In addition, not all areas on the skull may be equal in terms of efficiency for bone conduction transducers. Therefore, the actual efficiency of audio energy transfer between a bone conduction transducer and the bones of the user may vary considerably from user to user, from position to position and from varying pressure of the attachment of the transducer to the head.

Accordingly, measurements related to bone conduction devices (and/or performance thereof) may be obtained, and processed to assess quality of bone conduction (e.g., quality of contact between a bone conduction device and body of a user—i.e. wearer of the bone conduction device). Further, indications of the quality (e.g., quality of contact) may be generated, and presented to the user. The indication may be based on any one, or a combination, of a variety of quality assessing criteria or methods, using existing data that may be used as performance benchmark (e.g., typical bone conduction data, as represented by the charts of FIGS. 2A and 2B for example, and/or bone conduction indirect measurements, which may be taken on the specific user and stored for use as reference thereafter). The quality indications may comprise simple indicators (e.g., either ‘good’ or ‘bad’ indications), or it may be more complex indication (e.g., graduated reading of quality). Further, various means may be used in presenting the quality indications. For example, quality indications may be configured as audible signals, visual signals, or combination thereof. The quality indications may be used to assure device users that the bone conduction device (e.g., transducer) is connected optimally ahead of any operation of the host device or transducer (thus, before suffering any unnecessary discomfort, where the device is applying too much force, or before experiencing a failure of performance, where the device is poorly connected and as such no sufficient transfer would take place). As a result, there would be no need to re-adjust the positioning (e.g., during a call, or in the midst of listening to messages or audio files). This may be particularly desirable as re-adjusting bone conduction elements may be annoying or may even be dangerous (e.g., if the user is trying to re-adjust while driving).

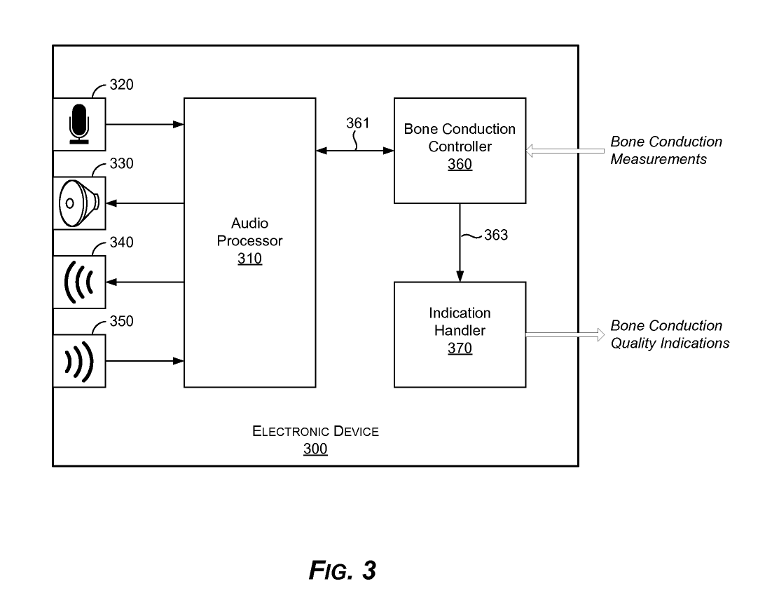

FIG. 3 illustrates an example electronic device that may support near-end listening intelligibility enhancement. Referring to FIG. 3, there is shown an electronic device 300.

The electronic device 300 may comprise suitable circuitry for implementing various aspects of the disclosure. The electronic device 300 may be operable to, for example, perform or support various functions, operations, applications, and/or services. The functions, operations, applications, and/or services performed or supported by the electronic device 300 may be run or controlled based on user instructions and/or pre-configured instructions. The electronic device 300 may be a stationary device (e.g., desktop computer). Alternatively, the electronic device 300 may be a mobile and/or user-supported device (i.e. intended to be supported by a user, such as by being held or worn by the user, during use of the device), thus allowing for use of the device on the move and/or at different locations. In this regard, the electronic device 300 may be designed and/or configured to allow for ease of movement, such as to allow it to be readily moved while being supported by the user as the user moves, and the electronic device 300 may be configured to perform at least some of the operations, functions, applications and/or services supported by the device on the move.

In some instances, the electronic device 300 may support input and/or output of audio and other acoustic signals. The electronic device 300 may incorporate, for example, a plurality of audio input and/or output (I/O) components (e.g., microphones, speakers, and/or other audio I/O components), for use in outputting (playing) and/or inputting (capturing) audio, along with suitable circuitry for driving, controlling and/or utilizing the audio I/O components.

Examples of electronic devices may comprise handheld electronic devices (e.g., cellular phones, smartphones, and tablets), computers (e.g., desktops and laptops), dedicated media devices (e.g., portable media players), and the like. Further, in some instances, the electronic device 300 may be a wearable device—i.e. may be worn by the device's user rather than being held in the user's hands. Examples of wearable electronic devices may comprise digital watches and watch-like devices (e.g., iWatch), glasses-like devices (e.g., Google Glass), or any suitable wearable listening and/or communication devices (e.g., Bluetooth earpieces). The disclosure, however, is not limited to any particular type of electronic device.

For example, as shown in the example implementation depicted in FIG. 3, the electronic device 300 may comprise an audio processor 310, an audio input device (e.g., a microphone) 320, an audio output device (e.g., a speaker) 330, bone conduction elements 340 and 350 (e.g., for use, respectively, in outputting and inputting acoustic signals based on bone conduction), a bone conduction controller block 360, and an indication handler 370.

To the extent that it is used in conjunction with bone conduction, the electronic device 300 may correspond to, for example, any of the devices (112, 122, and 132) of the bone conduction arrangements 110, 120, and 120 of FIG. 1. In this regard, the microphone 320 and the bone conduction element 350 may be used in inputting (e.g., capturing) audio or other acoustic signals; whereas the speaker 330 and the bone conduction element 340 may be used in outputting audio (or other acoustic) signals from the electronic device 300. While speakers (e.g., the speaker 330) and microphones (e.g., the microphone 320) may be configured to output or input audio or acoustic signals based on transmission or reception of signals (e.g., via vibration of membranes) through the air, bone conduction elements are used in outputting or inputting audio (or other acoustic) signals via or through users' bones. For example, acoustics outputted by the bone conduction element 340 may cause vibrations in the bones, in a controlled manner, such that the signals can be captured by the internal parts of the ear, bypassing the eardrum. On the other hand, the bone conduction element 350 may be configured to capture vibrations propagating through the user's bones (e.g., as result of the user talking).

The audio processor 310 may comprise suitable circuitry for performing various audio signal processing functions in the electronic device 300. The audio processor 310 may be operable, for example, to process audio signals captured via input audio components (e.g., the microphone 330), to enable converting them to electrical signals—e.g., for storage and/or communication external to the electronic device 300. The audio processor 310 may also be operable to process electrical signals to generate corresponding audio signals for output via output audio components (e.g., the speaker 320). The audio processor 310 may also comprise suitable circuitry configurable to perform additional, audio related functions—e.g., voice coding/decoding operations. In this regard, the audio processor 310 may comprise analog-to-digital converters (ADCs), one or more digital-to-analog converters (DACs), and/or one or more multiplexers (MUXs), which may be used in directing signals handled in the audio processor 310 to appropriate input and output ports thereof. The audio processor 310 may comprise a general purpose processor, which may be configured to perform or support particular types of operations (e.g., audio related operations). Alternatively, the audio processor 310 may comprise a special purpose processor—e.g., a digital signal processor (DSP), a baseband processor, and/or an application processor (e.g., ASIC).

The bone conduction controller block 360 may comprise suitable circuitry for managing and/or controlling bone conduction related operations or functions in the electronic device 300. For example, the bone conduction controller block 360 may be configured to obtain measurements relating to bone conduction elements, or functions thereof (e.g., with respect to outputting or inputting of signals), processing of the measurements, such as to enable assessing various quality related parameters associated with the bone conduction elements or operations thereof. The bone conduction controller block 360 may also be configurable to determine adjustments of functions and/or parameters relating to bone conduction operations in the electronic device 300 (e.g., via the bone conduction elements 240 and 250, and/or bone conduction related processing in the audio processor 210).

The indication handler 370 may comprise suitable circuitry for generating and/or outputting indications, to users of the electronic device 300. The indications may be configured for various means of presentation. For example, indications may be audible (e.g., particular sounds), visual (e.g., particular colors and/or lighting patterns), and the like. The disclosure is not limited, however, to any particular type of indication. The indication handler 370 may be configured to generate indications relating to different operations and/or components of the electronic device 300. For example, the indication handler 370 may be configured to generate indications of bone conduction quality.

In operation, the electronic device 300 may be utilized in supporting input and/or output of audio (and other acoustic) signals. For example, when the electronic device 300 is used to input audio, audio signals may be captured via the microphone 320, and be processed in the audio processor 310—e.g., converting them into digital data, which may then be stored and/or communicated external to the electronic device 300. When the electronic device 300 is used to output audio, the electronic device 300 may receive (from other electronic devices) or read (e.g., from internal storage resources or suitable media storage devices) signals carrying audio content, process the signals to extract the data corresponding to the audio content, and then process the data via the audio processor 310 to convert them to audio signals. The audio signals may then be outputted via the speaker 330. In some instances, the audio signals may be inputted and/or outputted (in lieu of or in addition to via the microphone 320 and/or the speaker 330) using bone conduction. In this regard, audio signals intended for output may be processed particularly via the audio processor 310, to make them suited for outputting via the bone conduction element 340. On the other hand, the bone conduction element 350 may be used to capture signals (e.g., vibrations propagating in user's bones, corresponding to audio such as speech), with the captured signals being processed in the audio processor 310.

In some instances, it may be desirable to monitor and control certain aspect of bone conduction in the electronic device 300. In this regard, as described in more detail with respect to FIG. 1, monitoring and controlling bone conduction may comprise obtaining measurements relating to bone conduction elements or functions thereof, which may then be processed to assess quality of various aspects of bone conduction. Further, indications of bone conduction may be generated, based on the assessment of quality, and presented to users. For example, various bone conduction elements may have relatively small contact size (e.g., in the order of 1 cm²) with the user's body (e.g., user's head), with force of 250 to 500 g being generally considered as necessary to achieve good performance. Using such a force, however, on such a small area may cause discomfort to the user, resulting in the user moving the bone conduction element in order to find a comfortable position—i.e. positions which would alleviate discomfort felt when forces suitable for good performance are applied. Nonetheless, the comfortable position(s) may or may not result in be optimum or even satisfactory operation of the bone conduction elements with respect to audio quality and/or loudness (because not all areas on the user's body—e.g., skull—may be equal in terms of efficiency for a bone conduction). Thus, measuring bone conduction may allow for locating position(s) that may provide the best combination of performance and comfort.

For example, the bone conduction controller 360 may be configured to provide the monitoring and/or controlling of bone conduction. In this regard, the bone conduction controller 360 may incorporate or be coupled to components used during bone conduction operations (e.g., the bone conduction elements 340 and 350) as well as sensory components (e.g., suitable gauges, meters, and the like) which may be used in obtaining bone conduction measurements—e.g., impedance related measurements and the like. The bone conduction controller 360 may incorporate circuitry for processing the obtained measurements, such as to enable assessing quality of various aspects of bone conduction elements or operations (e.g., attachment of elements to user's bones).

In some instances, the bone conduction controller 360 may be configured to determine adjustments of certain bone conduction related components (e.g., bone conduction elements 340/350) and/or bone conduction related functions (e.g., bone conduction related functions in the audio processor 310). The adjustments may be communicated via control signals (e.g., control signal 361), which may be used in adjusting audio processing and/or signal outputting parameters (e.g., equalization and/or the level of audio driver amplifiers used in bone conduction elements/transducers).

In some instances, the bone conduction controller 360 may generate quality related data, which may be used in generated quality indication. For example, the bone conduction controller 360 may provide results of quality assessment of bone conduction (e.g., via control signal 363) to the indication handler 370. The indication handler 370 may then process the quality related information, to generate a corresponding quality indication which may be configured for presentation to the user based on one or more available means—e.g., as audible and/or visual signals, indicating quality of certain aspects of bone conduction (e.g., quality of attachment). The quality indication may be configured as simple ‘good’ or ‘bad’ indications. The quality indication may also be configured as a graduated indication—i.e., a range of different values. Use of such quality indication may be desirable as it may allow users to ensure that audio quality would be good prior to the actual use. Further, once quality of a bone conduction element is assessed to be good (e.g., the element, as attached, is comfortable and/or performance is good), the quality indication may be calibrated (e.g., via the indication handler 370). In this regard, when the quality indication is calibrated for a particular bone conduction element, the user may easily return to the same position for that element resulting in that calibrated indication, each time the bone conduction element is in contact with the user, by making fine adjustments of the position, using the quality indication as an aid.

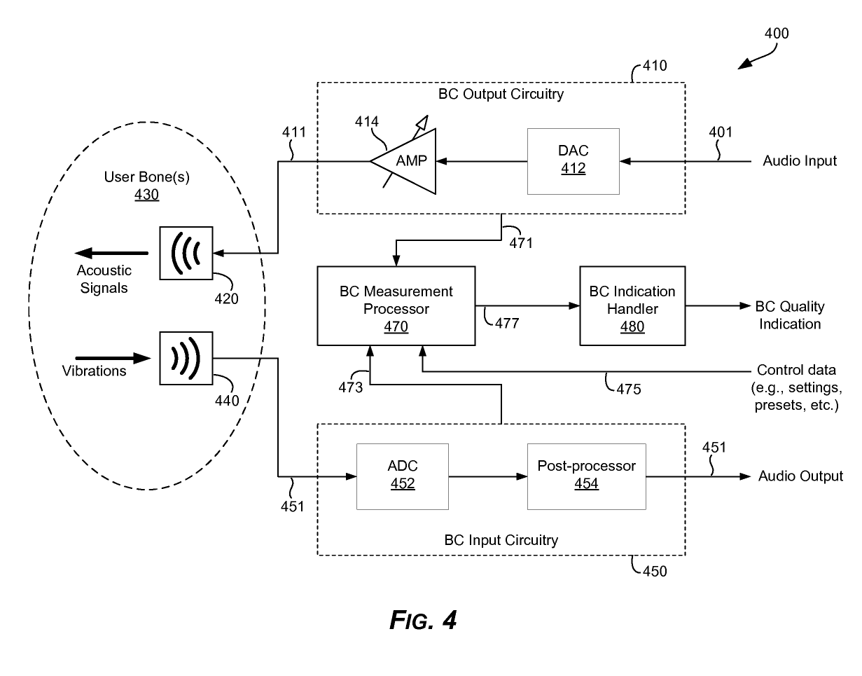

FIG. 4 illustrates an example system that may support assessing quality of bone conduction, and providing quality based indications to users. Referring to FIG. 4, there is shown a system 400.

The system 400 may comprise suitable circuitry for inputting and/or outputting audio and/or other acoustics via bone conduction, and/or for providing adaptive control thereof, particularly based on quality measurements. The quality measurements may be obtained based on sensory of the bones (e.g., sensing of vibrations therein associated with bone conduction induced by the bone microphone), data relating to circuitry used in the input/output operations (amount of energy estimated to being successfully transferred to the bone(s). Further, in some instances analyzing bone conduction related measurements, to assess quality of bone conduction, may also be based on configured control parameters. In this regard, the configured control parameters may correspond to settings and/or presets defining specific optimal bone conduction operations for a particular user (e.g., optimal placement for the user). Thus the system 400 may correspond to the electronic device 300 (or components there of that are utilized in conjunction with bone conduction).

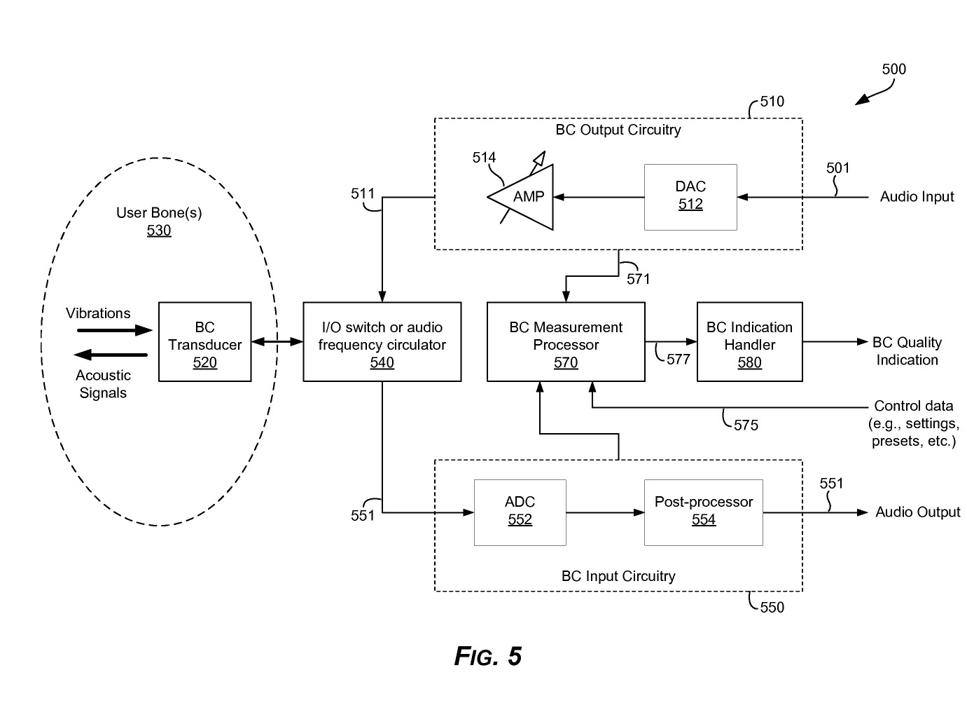

For example, as shown in FIG. 4, the system 400 may comprise bone conduction output circuitry 410, an output bone conduction element 420, an input bone conduction element 440, bone conduction input circuitry 450, a measurements processor 470, and an indication handler 480. Nonetheless, in some implementations, only a subset of these elements may be used in the system 400. For example, in some instances only bone conduction transmission (or reception) may be desired, and as such, bone conduction input (or output) components may be eliminated. Further, in some example implementations, the bone conduction may be done using a single element (e.g., bone conduction transducer) which may be operable to handle both output and input functions. FIG. 5 illustrates one such implementation.

The bone conduction output circuitry 410 may comprise suitable circuitry for converting audio input into corresponding acoustic signals that are outputted by application (e.g., in the form of vibrations) into bones (e.g., user bones 430). For example, the bone conduction output circuitry 410 may comprise a digital-to-analog convertor (DAC) 412 and an amplifier 414. The amplifier 414 may be a variable equalizer and or gain amplifier. The bone conduction input circuitry 450 may comprise suitable circuitry for converting captured or sensed vibrations (user bones 430) into corresponding audio output. For example, the bone conduction input circuitry 450 may comprise an analog-to-digital convertor (ADC) 452 and a post-processor 454. Each of the output bone conduction element 420 and the input bone conduction element 440 may comprise a bone conduction transducer.

The measurements processor 470 may comprise circuitry for processing bone conduction related measurements, such as to provide data that may be used for adaptive control or handling of bone conduction related elements and/or operations in the system 400.

The measurements processor 470 may be configured to handle “indirect” measurements. In this regard, rather than using direct measurement of bone conduction and/or bone conduction elements/transducers, quality of bone conduction may be assessed based on measurements associated with components used in driving and/or operating the bone conduction elements. In particular, measurements of such components that may specifically (and in known manner) affect or be affected by bone conduction, may be indicative of certain characteristics of bone conduction, and as such may be indicative of the quality of bone conduction. Accordingly, the measurements processor 470 may be configured to obtain such indirect measurements, and may process these measurements to assess quality of bone conduction. For example, the measurements processor 470 may receive data from the bone conduction output circuitry 410, the output bone conduction element 420, the input bone conduction element 440, and/or the bone conduction input circuitry 450, which may be used by the measurements processor 470 as (indirect) measurements of bone conduction, and may be analyzed to assess quality of the bone conduction. The measurements processor 470 may receive, for example, input 471 from the bone conduction output circuitry 410, reporting one or more bone conduction related parameters as applicable in a bone conduction output path, and/or may receive input 473 from the bone conduction input circuitry 450, reporting one or more bone conduction related parameters as applicable in a bone conduction input path. The measurements processor 470 may then analyze the reported parameter(s), to assess quality of the bone conduction. For example, quality of bone conduction may be assessed based on impedance related measurements of the output stage of the amplifier 414.

In some instances, the measurements processor 470 may be configured to determine (and effectuate, e.g., using control signals) adjustments to audio related operations or functions in the system 400. For example, the measurements processor 470 may be configured to determine gain and/or equalization adjustments that may be applied to the amplifier 414.

The indication handler 480 may comprise circuitry for generating and/or presenting indications (e.g., indications of bone conduction quality), as described with respect to the indication handler 370 of FIG. 3 for example.

In operation, the system 400 may be utilized to provide audio input and/or output based on bone conduction. Further, the system 400 may be configured to make determinations as to quality of bone conduction (e.g., with respect to overall operations and/or functions of elements used during such operations), and to use such determinations, such as to provide indications of quality to users and/or to enable adaptive adjustment or control of bone conduction. For example, the system 400 may be configured to output, based on bone conduction (e.g., in the form of vibrations caused in the user bones 430), acoustics signals (within audible range), corresponding to an input audio signal 411, such as by processing the signal for bone conduction via the bone conduction output circuitry 410, for injunction into the user's bones 430. In this regard, the input audio signal 411 may typically be in digital form, and as such it would be first converted to an analog form by the DAC 412. The output of the DAC 412 may then be applied as input to the amplifier 414, the output of which may be used in driving the bone conduction element 430. The bone conduction element 430 may be coupled to a user's skull bones 440, and the vibrations from the bone conduction element 430 are transferred via the bone to the inner parts of the ear, bypassing the eardrum.

The system 400 may also be configured to support input (e.g., capture) of acoustics signals based on bone conduction (e.g., vibrations traversing the user bones 430), and to generate a corresponding output audio signal 451. In this regard, the bone conduction element 440 may be coupled to a user's bones 430, and vibrations propagating through the bones may be captured via the bone conduction element 440, are transferred (as analog signals 441) to the bone conduction input circuitry 450 for processing thereby. The output audio 451 signal may typically be in digital form, and as such it would be first converted from analog form by the ADC 452, and then processed via the post-processor 454.

In some instances, the system 400 may support obtaining measurements relating to bone conduction operations, and/or using such bone conduction related measurements in enhancing bone conduction. For example, the obtained measurements may be processed, to assess quality of bone conduction (and to generate corresponding quality indications for presentation to system user(s)), and/or to determine when/if adjustments may be applied to components or functions used during input and/or output of audio via bone conduction.

For example, actual efficiency of audio energy transfer between bone conduction elements (e.g., transducers) and bones (e.g., user's bones 430) may vary considerably—e.g., from user to user, from position to position, and/or based on varying of pressure of the attachment to the body (e.g., head) of the user. Thus, impedance measurements may be used to obtain bone conduction related measurement(s). The bone conduction related measurement(s) may then be provided to the measurements processor 470, which may then process the measurement(s).

In some instances, bone conduction measurement may be done by using co-located (or closely located) bone conduction elements (e.g., a microphone and a speaker), thus allowing operations of one of the elements (e.g., the speaker) for measuring the signals of the other element (e.g., measuring signals collected from the microphone). Nonetheless, in various implementations, rather than obtain direct measurements of bone conduction, which would require use of dedicated elements (e.g., bone conduction sensors), assessing quality of bone conduction may be based on “indirect” measurements—e.g., measurements relating to various system components that may be used during bone conduction (or functions thereof), and/or analysis of parameters used in conjunction with functions of such components during bone conduction operations. In other words, assessing quality of bone conduction in this (indirect) manner may entail measuring (and analyzing) measurements of components and/or parameters that may affect (and/or may be affected by) bone conduction. For example, electrical impedance of certain components used in bone conduction output and/or input paths (e.g., the final stage of output amplification, such as of the amplifier 414) may be influenced by or relate to bone conduction characteristics—e.g., acoustic impedance of bone conduction elements, thus amount of energy that the bone conduction elements may be able to transfer to the bones. Another measurement that may be used is the reflectance coefficient, which may be measured, e.g., at the final stage of output amplification.

In an example implementation where bone conduction assessment is based on impedance measurements, the measurements processor 470 may receive impedance data of certain components used during bone conduction, which in turn may be used as indirect indications of impedance of the bone conduction (and thus allowing assessing quality thereof). For example, the measurements processor 470 may receive the input 471, which may report impedance of the bone conduction output stage (e.g., impedance of the output stage of the amplifier 414), and/or the input 473, which may report the level of the signal reflected from the bone(s) as a result of the incident signal transmitted by the bone conduction transducer 420. In this regard, the level of the reflected signal (“reflection coefficient”) may be derived from the input 451, and may be indicative of bone conduction placement quality. The measurements processor 470 may then process the measurement data (e.g., the reported impedance of the amplifier 414 and/or the reflection coefficient, as derived from the input 451 of the bone conduction input circuitry), to determine the impedance of bone conduction.

In some instances, measurements may be obtained only from either one of the input or output stages, with such measurements being sufficient to provide overall bone conduction measurements. For example, obtaining measurement relating to bone conduction output stage (or path) may be sufficient by itself (to enable assessing overall quality of bone conduction). In this regard, bone conduction output stage/path measurements may comprise or correspond to the amount of energy transferred to the bones, the impedance of the final amplification stage, etc.

The processing of measurements by the measurements processor 470 may result in determining or estimating of quality of one or more aspects relating to bone conduction (e.g., quality of attachment). The quality related info may be forwarded (e.g., as control signal 477) to the indication handler 480, which may generate corresponding quality indication(s). In this regard, the generated quality indication(s) may be configured for presentation to the system user (e.g., as audible or visual signals).

The system 400 may be configured for performing the bone conduction related measurement(s), and/or the processing of the obtained measurement(s) (e.g., for assessing quality of bone conduction) in different ways. For example, the bone conduction related measurements may comprise measuring responses at different frequencies. Processing of the measurements may then comprise comparing the ratios of the responses to a set of pre-determined thresholds. In some instances, the bone conduction related measurement(s) may comprise measuring impedance (e.g., acoustic impedance for bone conduction transducers, obtained directly, or indirectly, such as based on electrical impedance of components used during bone conduction operations), such as at one or more specific frequencies. The processing of the measurement(s) may then comprise comparing the measurement(s) with a pre-determined set of threshold parameters, and the quality of bone conduction (e.g., attachment of bone conduction elements) may then be based on the comparisons. Several methods may be used for measuring impedance matching (of the bone conduction element/transducer), including, for example: 1) measuring the absolute value of the S-parameters and S11 in particular; 2) measuring the impedance, voltage and/or current applied to signals fed to and/or generated by the bone conduction element/transducer (applied to components used in conjunction with operation of the bone conduction element/transducer, e.g., last stage of amplification, such as the amplification performed in the amplifier 414); 3) measuring the standing wave ratio (SWR), such as at the input to the bone conduction element/transducer—e.g., using a bone microphone in the measurement location, or using a transducer as a microphone as well as a speaker; and 4) measuring power consumed when feeding or driving the bone conduction element/transducer (e.g., by the last stage of amplification, such as by the amplifier 414).

In some instances, the bone conduction measurement(s) may comprise measuring the resonant frequency of the transducer, and then comparing, when processing the measurement(s), the result to a pre-determined threshold. In one example implementation, a measurement may be obtained, in systems comprising bone conduction elements used as a combination of speaker and microphone transducers, by transmitting a signal to the ‘speaker’ end (i.e., bone conduction element 420), measuring the response of the ‘microphone’ end (i.e., bone conduction element 430), and then determining whether the combined response is above a certain threshold. Gain control and equalization of the signal may then be applied in order to correct the response, either at the speaker end or at the microphone end.

In one example implementation, measurements may be done in different methods (e.g., using all the methods described hereto), such as during a “calibration” period—e.g., during the time of the initial wearing of the device by the wearer—and then a comparison of all of the measurements taken in all of the methods may be performed. The settings corresponding to the best outcome (in term of performance and comfort) based on the measurements may then be marked (e.g., using particular quality indication). In subsequent uses an indication to the user could be provided to show that the device is in the correct position, particularly relative to such optimal positions, and/or that the element is (or not) attached correctly. The settings and/or presets corresponding to such optimal positions may be provided to the measurements processor 470 as control input 475, to enable assessing quality of bone conduction subjectively—that is particularly for a specific user's preferences, such as by evaluating the measurement in view of the such predetermined settings and/or presets.

In some instances, a measurement (and assessed quality based thereon) may be used to control adjusting of bone conduction related components or functions. For example, in some instances where bone conduction measurement may result in quality indication that may be too low or not registering, effective gain of the transducer may be automatically increased to compensate for the poor connection. In some instances, the quality indication may be used to control an automatic gain adjustment procedure, such as the volume of a bone conduction element used as a speaker and/or a gain of a bone conduction element used as microphone may be automatically adjusted until the quality indication is within certain limits. Another type of adjustments that may be made, based on assessment of quality of bone conduction, is impedance related adjustments—e.g., impedance tuning of the output stage of the amplifier 414 and/or the input stage of ADC 452.

FIG. 5 illustrates an example system that may support assessing quality of bone conduction done using single bone conduction transducer, and providing quality based indications to users. Referring to FIG. 5, there is shown a system 500.

The system 500 may be substantially similar to the system 400 of FIG. 4, for example. In this regard, the system 500 may comprise suitable circuitry for inputting and/or outputting audio and/or other acoustics via bone conduction, and/or for providing adaptive control thereof, particularly based on quality measurements. The quality measurements may be obtained based on sensory of the bones (e.g., sensing of vibrations therein associated with bone conduction induced by the bone microphone), and or on data relating to circuitry used in the input/output operations (amount of energy estimated to being successfully transferred to the bone(s). Further, in some instances analyzing bone conduction related measurements, to assess quality of bone conduction, may also be based on configured control parameters. In this regard, the configured control parameters may correspond to settings and/or presets defining specific optimal bone conduction operations for particular user (e.g., optimal placement for the user). Thus the system 500 may correspond to an alternate implementation of the electronic device 300 (or components thereof that are utilized in conjunction with bone conduction).

Unlike the system 400 of FIG. 4, in which separate bone conductions elements are used, respectively, for input and output operations, the system 500 may utilize a single bone conduction element that may be utilized for both input and output operations. For example, as shown in FIG. 5, the system 500 may comprise bone conduction output circuitry 510, bone conduction input circuitry 550, a bone conduction transducer 520, and an input/output (I/O) switch or audio frequency circulator 540. Further, the system 500 may comprise bone conduction related control components, such as a measurements processor 570 and an indication handler 580.

The bone conduction output circuitry 510 and bone conduction input circuitry 550 may be similar to the bone conduction output circuitry 410 and the bone conduction input circuitry 450 of the system 400 of FIG. 4, for example, and may operate in substantially similar manner. Nonetheless, rather than driving or be driven by corresponding dedicated bone conduction elements (e.g., the output bone conduction element 420 and the input bone conduction element 440 in system 400) the bone conduction output circuitry 510 and bone conduction input circuitry 550 may co-utilize the bone conduction transducer 520. In this regard, the bone conduction transducer 520 may be configurable to function both as bone conduction transmitter (e.g., speaker) and a bone conduction receiver (e.g., microphone). Accordingly, bone conduction transducer 520 may be reconfigured dynamically to function as an input element or as an output element, when needed. Further, the I/O switch 540 may comprise suitable circuitry for handle forwarding of signals to and/or from the bone conduction transducer 520, such as based on the configured function thereof. Thus, during bone conduction output operations, the I/O switch 540 may forward output of the bone conduction output circuitry 510 to the bone conduction transducer 520; whereas during bone conduction input operations, the I/O switch 540 may pass output of the bone conduction transducer 520 (e.g., captured vibration) to the bone conduction input circuitry 510.

Further, in some instances, the input signal may be measured concurrently with transmitting of the output signal, using such techniques as echo cancellation for example. Thus, in some implementations, the I/O switch or audio frequency circulator 540 may comprise circuitry for enabling its configuration to function as acoustic frequency circulator, with all the processing being done in a similar way.

The system 500 may also be operable to support adaptive management of bone conduction, which may comprise obtaining measurement of bone conduction, assessing quality of bone conduction, and/or generating indications of quality of bone conduction, substantially as described with respect to system 400, for example. In this regard, each of the measurements processor 570 and the indication handler 580 may be similar to the measurements processor 470 and an indication handler 480 of the system 400, and may be configured to function in substantially similar manner. Accordingly, as with the system 400, the system 500 may support assessing bone conduction based on “indirect” measurements, such as measurements relating to components used in driving bone conductions element, and/or of parameters used or applied to such components.

For example, in an example implementation where bone conduction assessment is based on impedance measurements, the measurements processor 570 may receive impedance data of certain components used during bone conduction, which in turn may be used as indirect indications of impedance of the bone conduction (and thus allowing assessing quality thereof). For example, the measurements processor 570 may receive the input 571, which may report impedance of the bone conduction output stage (e.g., impedance of the amplifier 514), and/or the input 573 which may report the level of the signal reflected from the bone (using techniques such as acoustic echo cancellation) as a result of the incident signal transmitted by the bone conduction transducer 520, which is indicative of bone conduction placement quality. The measurements processor 570 may then process the measurement data (e.g., the reported impedance of the amplifier 514 and/or the level of reflected signal at input 551), to determine the impedance of bone conduction. The processing of measurements by the measurements processor 570 may result in determining or estimating of quality of one or more aspects relating to bone conduction (e.g., quality of attachment). The quality related info may be forwarded (e.g., as control signal 577) to the indication handler 580, which may generate corresponding quality indication(s). In this regard, the generated quality indication(s) may be configured for presentation to the system user (e.g., as audible or visual signals).

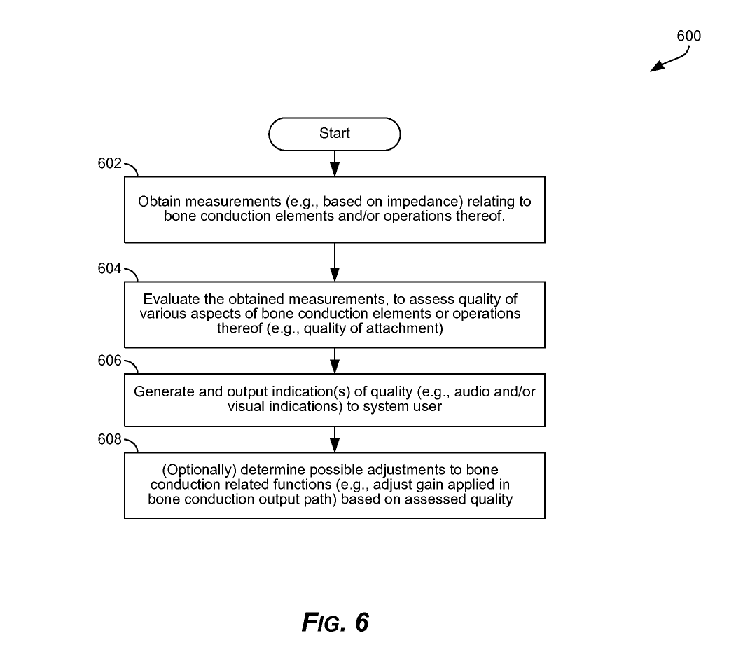

FIG. 6 is a flowchart illustrating an example process for generating quality indications for bone conduction based on measurement. Referring to FIG. 6, there is shown a flow chart 600, comprising a plurality of example steps, which may be executed in a system (e.g., the system 400 of FIG. 4 or the system 500 of FIG. 5) to provide adaptive measurement of bone conduction, and generating of quality indications based thereon.

In step 602, bone conduction related measurements (e.g., based on AMP 414 output stage impedance), relating to bone conduction elements and/or operations thereof, may be obtained (e.g., via the bone conduction measurement sensor 460).

In step 604, the obtained measurements may be processed, such as to enable assessing quality of various aspects of bone conduction elements or operations thereof (e.g., quality of attachment).

In step 606, indication(s) of quality (e.g., audio and/or visual indications) may be generated and presented to users. In step 608, possible adjustments to bone conduction related components and/or functions (e.g., adjust gain applied in bone conduction output path) may be determined based on assessed quality.

In some example implementations, a method may be used for controlling bone conduction in an electronic device (e.g., the electronic device 300). The method may comprise: determining one or more parameters relating to contact and/or conductivity of a bone conduction element (e.g., one of the bone conduction elements 340 and 350) that is in contact with a user; processing the one or more parameters, to determine or estimate quality of attachment and/or performance of the bone conduction element; and providing an indication of quality of attachment and/or performance of the bone conduction element to the user. In some instances, the method may comprise measuring, when determining the one or more parameters relating to contact and/or conductivity, responses of bone conduction transduction. Further, the method may comprise comparing, when determining the quality of attachment and/or performance of the bone conduction element, ratios of the responses to a plurality of pre-determined thresholds. The method may comprise measuring one or more responses of bone conduction transduction based on measurement of one or more impedance related parameters. The method may comprise providing the indication of quality visually and/or audibly. The method may comprise measuring one or more parameters affecting one or more functions related to operation of the bone conduction element, when determining the one or more parameters relating to contact and/or conductivity of the bone conduction element. The one or more functions related to the operation of the bone conduction element may comprise amplification applied in driving the bone conduction element. The method may comprise measuring one or more parameters related to impedance, voltage, and/or current associated with the amplification, to effectuate the adaptive controlling.

In some example implementations, a system comprising one or more circuits (e.g., the audio processor 310, the bone conduction controller 360, and/or the indication handler 370) for use in an electronic device (e.g., the electronic device 300), may be used for controlling bone conduction in the electronic device. The one or more circuits may be operable to: determine one or more parameters relating to contact and/or conductivity of a bone conduction element (e.g., one of the bone conduction elements 340 and 350) that is in contact with a user; process the one or more parameters, to determine or estimate quality of attachment and/or performance of the bone conduction element; and provide an indication of quality of attachment and/or performance of the bone conduction element to the user. The one or more circuits may be operable to measure, when determining the one or more parameters relating to contact and/or conductivity, one or more responses of bone conduction transduction. The one or more circuits may be operable to compare, when determining the quality of attachment and/or performance of the bone conduction element, ratios of the responses to a plurality of pre-determined thresholds. The one or more circuits may be operable to measure one or more responses of bone conduction transduction based on measurement of one or more impedance related parameters. The one or more circuits may be operable to provide the indication of quality visually and/or audibly. The one or more circuits may be operable to measure one or more parameters affecting one or more functions related to operation of the bone conduction element, when determining the one or more parameters relating to contact and/or conductivity of the bone conduction element. The one or more functions related to the operation of the bone conduction element comprise amplification applied in driving the bone conduction element. The one or more circuits may be operable to measure one or more parameters related to impedance, voltage, and/or current associated with the amplification, to effectuate the adaptive controlling.

In some example implementations, a system (e.g., the system 400 or the system 500) may be used for bone conduction and adaptive control thereof. The system may comprise a bone conduction element (e.g., one of the bone conduction elements 420 and 430, or the bone conduction transducer 520) that is operable to, when in contact with a user, output acoustic signals into bones of a user and/or receive acoustic signals propagating through the bones of the user; a processing circuit (e.g., the measurements processor 470 or the measurements processor 570) that is operable to process one or more parameters relating to contact and/or conductivity of the bone conduction element, to determine or estimate quality of attachment and/or performance of the bone conduction element; and an indication circuit (e.g., the indication handler 480 or the indication handler 580) that is operable to provide indication of quality of attachment and/or performance of the bone conduction element to the user. The one or more parameters may comprise at least one parameter relating to responses of bone conduction transduction. Further, the processing circuit may be operable to compare, when determining the quality of attachment and/or performance of the bone conduction element, ratios of the responses to a plurality of pre-determined thresholds. The one or more parameters may comprise at one measurement parameter relating to at least one function or component affecting operation of the bone conduction element. The at least one measurement parameter may comprise an impedance measurement. The indication circuit may be operable to provide the indication of quality visually and/or audibly.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for non-intrusive noise cancelation.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
in an electronic device:
determining one or more parameters relating to contact and/or conductivity of a bone conduction element that is in contact with a user;
processing the one or more parameters, to determine or estimate quality of attachment and/or performance of the bone conduction element; and
providing an indication of quality of attachment and/or performance of the bone conduction element to the user.

2. The method of claim 1, comprising measuring, when determining the one or more parameters relating to contact and/or conductivity, responses of bone conduction transduction.

3. The method of claim 2, comprising comparing, when determining the quality of attachment and/or performance of the bone conduction element, ratios of the responses to a plurality of pre-determined thresholds.

4. The method of claim 2, comprising measuring one or more responses of bone conduction transduction based on measurement of one or more impedance related parameters.

5. The method of claim 1, comprising providing the indication of quality visually and/or audibly.

6. The method of claim 1, comprising measuring one or more parameters affecting one or more functions related to operation of the bone conduction element, when determining the one or more parameters relating to contact and/or conductivity of the bone conduction element.

7. The method of claim 6, wherein the one or more functions related to the operation of the bone conduction element comprise amplification applied in driving the bone conduction element.

8. The method of claim 7, comprising measuring one or more parameters related to impedance, voltage, and/or current associated with the amplification, to effectuate the adaptive controlling.

9. A system, comprising:
one or more circuits for use in an electronic device, the one or more circuits being operable to:
determine one or more parameters relating to contact and/or conductivity of a bone conduction element that is in contact with a user;
process the one or more parameters, to determine or estimate quality of attachment and/or performance of the bone conduction element; and
provide an indication of quality of attachment and/or performance of the bone conduction element to the user.

10. The system of claim 9, wherein the one or more circuits are operable to measure, when determining the one or more parameters relating to contact and/or conductivity, one or more responses of bone conduction transduction.

11. The system of claim 10, wherein the one or more circuits are operable to compare, when determining the quality of attachment and/or performance of the bone conduction element, ratios of the responses to a plurality of pre-determined thresholds.

12. The system of claim 10, wherein the one or more circuits are operable to measure one or more responses of bone conduction transduction based on measurement of one or more impedance related parameters.

13. The system of claim 9, wherein the one or more circuits are operable to provide the indication of quality visually and/or audibly.

14. The system of claim 9, wherein the one or more circuits are operable to measure one or more parameters affecting one or more functions related to operation of the bone conduction element, when determining the one or more parameters relating to contact and/or conductivity of the bone conduction element.

15. The system of claim 14, wherein the one or more functions related to the operation of the bone conduction element comprise amplification applied in driving the bone conduction element.

16. The system of claim 15, wherein the one or more circuits are operable to measure one or more parameters related to impedance, voltage, and/or current associated with the amplification, to effectuate the adaptive controlling.

17. A system, comprising:
a bone conduction element that is operable to, when in contact with a user, output acoustic signals into bones of a user and/or receive acoustic signals propagating through the bones of the user;
a processing circuit that is operable to process one or more parameters relating to contact and/or conductivity of the bone conduction element, to determine or estimate quality of attachment and/or performance of the bone conduction element; and
an indication circuit that is operable to provide indication of quality of attachment and/or performance of the bone conduction element to the user.

18. The system of claim 17, wherein the indication circuit is operable to provide the indication of quality visually and/or audibly.

19. The system of claim 17, wherein the at least one of the one or more parameters relate to responses of bone conduction transduction.

20. The system of claim 19, wherein the processing circuit is operable to compare, when determining the quality of attachment and/or performance of the bone conduction element, ratios of the responses to a plurality of pre-determined thresholds.

21. The system of claim 17, wherein the one or more parameters comprise at least one measurement parameter relating to at least one function or component affecting operation of the bone conduction element.

22. The system of claim 21, wherein the at least at least one measurement parameter comprises an impedance measurement.
